(19) United States
(12) Patent Application Publication
(10) Pub. No.: US 2005/0217168 A1
(43) Pub. Date: Oct. 6, 2005

(54) Plant sheet and manufacturing method for plant sheet

(76) Inventor: Tomoko Fujita, Tottori-shi (JP)

Correspondence Address: WELSH & KATZ, LTD, 120 S RIVERSIDE PLAZA, 22ND FLOOR, CHICAGO, IL, 60606, US

(21) Appl. No.: 10/818,402

(22) Filed: Apr. 5, 2004

(51) Int. Cl. A01G 7/00

(52) U.S. Cl. 47/9

(57) ABSTRACT

A light-weight plant sheet including plant pieces between a base sheet and a top sheet is able to make growth by tearing the base sheet and top sheet, each having a mesh structure. The top sheet contains a paste to adhere the top sheet and the base sheet and to hold the plant pieces, and such a paste comes out of the fibers of the sheet when wet during the manufacturing process. When the plant sheet is placed at the construction site, the plant pieces can grow using water and nutrition provided from the surface of the construction site and absorbed in the top sheet and the base sheet.

### BACKGROUND OF THE INVENTION

1. Field of the Invention

This invention relates to a plant sheet for covering rock surfaces, concrete surfaces, and bare grounds and a method for manufacturing such a plant sheet.

2. Description of Related Art

Greening draws attentions for relaxation of the so-called heat island effects in urban areas, improvements in air environments done by direct absorption and settlement of C0₂ through trees, and bases for growth and nurture of various creatures. Because spaces with greens and waters bring natural feelings to human beings, coverage with greens over concrete wall surfaces, soilless rock surfaces, and bare dried grounds provides suitable environment to many people living thereon. According to recent experiments, a greened surface on a roof of a building generally indicates a lower temperature, e.g., about 15 degree Celsius lower than a comparable concrete surface, and keeps warm during the winter time and cool during the summer time. Greening has significant impacts to various creatures, as well. Such as insects, birds may live well even on a roof area of a building, which is otherwise covered with concrete surfaces.

Greening by plants may bring better sceneries to not only urban area but also newly developed and undeveloped areas, road or riversides. When a new road is extended through cutting mountain areas, one-side of the road would be remained with, e.g., soilless rock surfaces and concrete surfaces. Such artificially created surfaces sometimes lack harmony with natural surroundings, and plants, if filled over such bare grounds and soilless rock surfaces, may work as desirable fillings for regaining the natural harmony.

Plant sheets, tapes, and trays have been known for covering such artificially created surfaces. Plant trays having a depth for keeping soil can be arranged in a plural number on a roof to make the roof green. In a typical case, each tray is in a rectangular or square shape and is placed with soil for growing plants. Such plant trays, however, raise the following problems. First, the plant tray is generally in a prescribed standard size, and when a roof is fully covered with such trays, it is not easy to fill the space at the edges. Partly cut trays are not operable as normal trays because soil or water may dissipate from the cut section of the trays.

In a meantime, some plant sheet can be of a free size and can fit to any areas, because the sheet can be cut according to the place to be attached. Such a sheet also holds the soil at which the plants are growing. However, some plant sheets serve only for mulch purposes, or preventing water from evaporating overly and the plants from receiving damages due to frosts. Such a mulch sheet generally does not have germination facilities, and therefore, seeding in addition to placing the plant sheet may be required for growing plants on soilless surfaces such as concrete surfaces. Some plant sheets have a soil layer from which germination and cultivation of plants is possible, but addition of a soil layer requires extra manufacturing steps and likely causes the production price to be higher. The soil layer in the plant sheet also makes the plant sheet heavier and thicker and therefore makes handling by the operators uneasy.

### SUMMARY OF THE INVENTION

It is an object of the invention to provide a plant sheet that can be placed at any surfaces, such as rock surfaces, concrete surfaces, and bare grounds and that can be handled easily by the operators.

It is another object of the invention to provide a manufacturing method for manufacturing such a plant sheet.

The foregoing objects are accomplished by the invented plant sheet for cultivating a plant including a base sheet made of a naturally dissolvable fabric having a mesh structure, a top sheet made of a tearable sheet having a mesh structure and placed on the base sheet, the top sheet being torn by growth of the plant, and a plurality of plant pieces, from which the plant is able to make growth, arranged between the base sheet and the top sheet adhered in an area contact to the base sheet with a paste.

According to a preferred embodiment of the invention, the top sheet may be constituted of a fabric made of a water-soluble material and a biodegradable material, and the water-soluble material may work as a paste for making the top sheet and the base sheet adhere to each other. The the plant pieces can be made chiefly of leaves and stems of a plant capable of forming adventitious roots. In some cases, the plant pieces are of one or more succulent plants, one or more cacti, or a combination of succulent plants and cacti, and in more particular embodiments, the plant pieces may include one or more of sedums.

In another aspect of the invention, the above plant sheet includes a net placed between the top sheet and the base sheet for supporting the plant pieces. With the net, the plant pieces can be anchored to the net even after the top sheet and the base sheet are dissolved, so that the plant can grow adequately on a slope.

In still another aspect of the invention, a manufacturing method for a plant sheet comprising the steps of: preparing a base sheet as to spread on a work table; scattering a plurality of plant pieces from which the plant is able to make growth; overlaying a top sheet made of a water-soluble material, on the base sheet to sandwich the plant pieces between the top sheet and the base sheet; spraying water on the top sheet to partly solve the top sheet and adhere the top sheet to the base sheet; and drying the water contained at the top sheet and the base sheet.

### BRIEF DESCRIPTION OF THE DRAWINGS

The above and other objects and features of the invention are apparent to those skilled in the art from the following preferred embodiments thereof when considered in conjunction with the accompanied drawings, in which:

FIG. 1 is a perspective view showing a plant sheet according to an embodiment of the invention;

FIG. 2 is a perspective view showing the plant sheet according to the embodiment of the invention;

FIG. 3 is a cross section showing the plant sheet according to the embodiment of the invention;

FIG. 4 is a perspective illustration showing a plant sheet according to another embodiment of the invention;

FIGS. 5(a) to 5(d) are process illustrations showing a construction process of the plant sheet of the invention;

FIG. 6 is a diagram showing a manufacturing process for a plant sheet according to the invention; and

FIG. 7 is a diagram showing another manufacturing process for a plant sheet according to the invention.

### DETAILED DESCRIPTION OF THE PREFERRED EMBODIMENTS

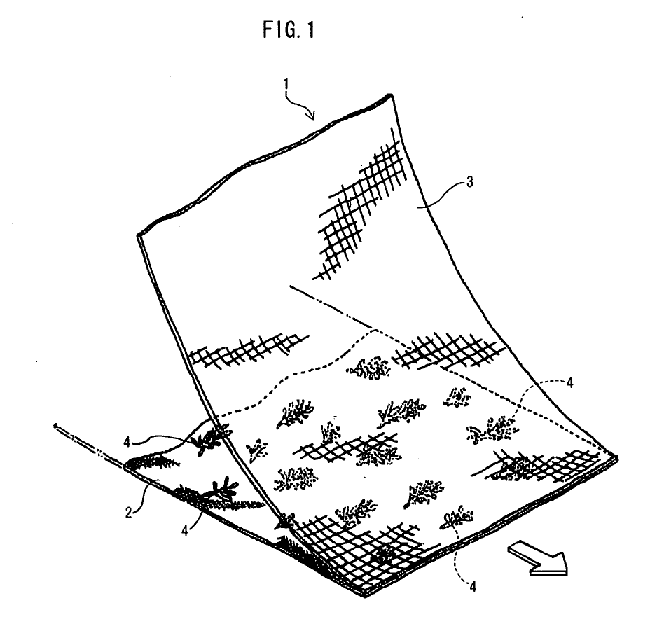

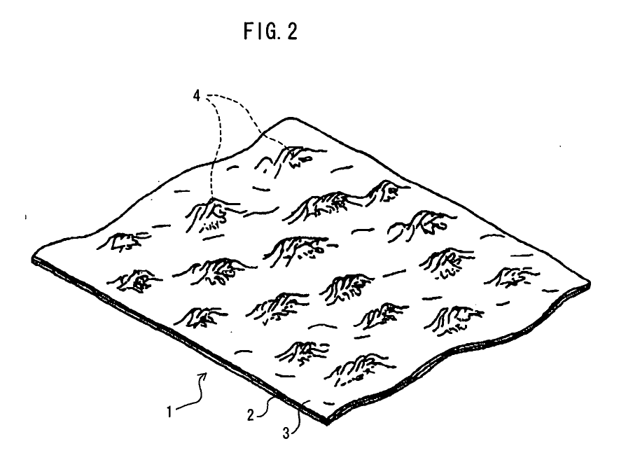

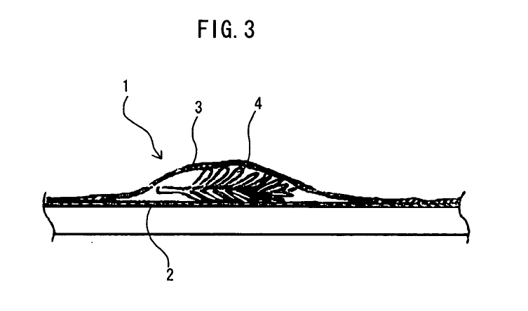

Referring to FIGS. 1 to 3, a plant sheet according to a first embodiment of the invention is described in detail. The plant sheet 1 shown in FIG. 1 is made of a base sheet 2 made of a naturally dissolvable fabric having a mesh structure, a top sheet 3 made of a tearable sheet having a mesh structure and placed on the base sheet 2, and a plurality of plant pieces 4, from which the plant is able to make growth, arranged between the base sheet 2 and the top sheet 3 adhered in an area contact to the base sheet 2 with a paste.

The base sheet 2 is for holding the plant pieces 4 with the top sheet 3 by sandwiching the plant pieces 4 between the base sheet 2 and the top sheet 3. The base sheet 2 also works for adhering the plant sheet 1 to bare grounds or concrete or rock surfaces. In this embodiment, the base sheet 2 is made of a gauze generally used for medical treatments and made of a thin cotton fabric in a plain or leno weave. Such a gauze has a feature to absorb fluids adequately among cotton fibers in use of the capillary action and also has a feature to be dried easily. According to regulations in Japan, such a gauze is made by plainly weaving a pure cotton thread obtained from seeds of such as e.g., Gossypium hirsutum Linne or the like into a fabric and by defatting and bleaching the fabric. Because such a gauze is made from a natural plant, the gauze is generally biodegradable and can be dissolved as time goes. In addition, such a gauze is soft and matches to any surface shape including undulated, cracked, and partly sloped surfaces, and such a gauze is commercially available easily with a wide width and long length, so that it is easy to manufacture the plant sheet 1 with a larger size to make the product as a mass production. The base sheet 2 has a mesh structure through which plant's roots grow and anchor into the ground or surface below the base sheet 2. The mesh structure is preferably chosen as to have a relatively rough mesh for rendering the roots easily penetrate through the base sheet 2. The base sheet 2 also operates as a source for water supply, because the base sheet 2 has a capability to absorb water, rain or vapor

In this embodiment, the base sheet 2 is made of a gauze, but other natural fabric products can be used as the base sheet 2. For example, linen, jute, palm, ramie, cellulose based fiber including lyocel and tencel (trademarks), etc. can be used for base sheet 2. The gauze sheet is generally in white, but in this invention, the base sheet 2 can be in any color to match the surrounding thereof. If the plant sheet I is settled on a bare ground whose soil is in a dark brown, the base sheet 2 can be in dark brown to make the sheet itself not so much outstanding. It the plant sheet 1 is to be placed on a concrete roof of a building, the base sheet 2 can be in a color of the concrete surface to fit the roof color.

The top sheet 3 is for covering the base sheet 2 and plant pieces 4 placed on the base sheet 2. The top sheet 3 is a tearable sheet having a mesh structure made of a woven fiber and is to be torn by growth of the plant pieces. In this embodiment, the top sheet 3 is made of a paper sheet includes a paste. More specifically, the top sheet 3 is made of a water-soluble, paper based sheet in which a fabric material is mixed with a water-soluble resin material such as starch, and polyvinyl alcohol. The water-soluble resin material works as the paste when the top sheet 3 is placed on the base sheet 2 and water is supplied over the top sheet 3 during the manufacturing process of the plant sheet 1. Upon receiving the water, the top sheet 3 is dissolved to make the water-soluble resin material come out of the fiber woven. The paste come from the water-soluble resin material renders the base sheet 2 and the top sheet 3 closely adhering to each other with facial contact therebetween.

After reception of the water during the manufacturing process and water after placed on the construction sites, the top sheet 3 looses the strength thereof by dissolution of the water-soluble resin material and becomes easily tearable by the growth of the plant pieces 4. Where the plant sheet 1 is placed outside the buildings or houses, the plant sheet 1 receives rain and moisture according to the weather of the location. Because such rain and moisture makes the top sheet 3 further weakened, the growth of the plants can easily tear the weakened top sheet 3. In addition, the water-soluble resin material operates to firmly adhere the plant sheet 1 to the ground or concrete surface, so that the plant sheet 1 is adequately settled at the place at which the plant sheet I is placed first.

The top sheet 3 can be made of other bio-degradable materials. Exemplified is a polymer selected from poly(D-lactic acid), poly(L-lactic acid), a D-lactic acid-L-lactic acid copolymer, a D-lactic acid-hydroxycarboxylic acid copolymer, and a blend thereof. Those lactic based materials also can be mixed with paper material to form a biodegradable sheet suitable for this plant sheet 1. Such biodegradable fibers constituting the top sheet 3 may be formed into non-woven fabric, woven fabric or knitted webs thereby constituting a sheet. Specifically, it is possible to use woven fabric consisting of plain weave, twill fabric, leno weave, twist weave and a combination thereof, weft-knitted fabric, warp-knitted fabric, and laminated non-woven fabric comprising warps and wefts laminated and cemented therein.

Because the top sheet 3 is to be torn by the growth of the plant, the easiness of tearing by the plant may be controlled as varied according to regions, weathers, kinds of plants, situations of the construction sites, seasons of the construction, etc. Tearing the top sheet 3 is properly done after the plant adequately anchors into the surface on which the plant sheet 1 is placed and may be adjusted by blending a relatively durable bio-degradable resin into the paper sheet. The paste or glue come from the water-soluble resin material may also be adjusted by blending other materials to match to regions, weathers, kinds of plants, situations of the construction sites, seasons of the construction, etc. The top sheet 3 may be colored to match the color of the surface on which the plant sheet 1 is placed. In this embodiment, the top sheet 3 is in green to render viewers provide some relaxing feelings.

The plant pieces 4 are placed between the base sheet 2 and the top sheet 3 and makes growth after the plant sheet 1 is settled at the construction site. The plant pieces 4 are leaves and stems of plants that can grow after the plant sheet 1 is settled at the construction site and survive, even where no water is supplied, during storage and shipment of this plant sheet 1. The plant pieces 4 may include roots or other portions of the plant having substantial ability to regenerate the plant. The plant pieces 4 are the pieces of the plants that are durable against dryness and can grow without soil. Some plants have such ability to grow without soil under rare water supply even from plants' leaf or stem pieces. Representative plants having such ability are plants belonging to succulents and cactuses, and this invention can utilize cut pieces of leaves and stems of such plants.

The cut pieces 4 of the plants are scattered randomly but in an equally dispersed manner on the base sheet 2 during the manufacturing process. The size of the plant pieces 4 may be varied and typically from an inch to several inches. The plant pieces 4 are scattered over almost all area of the base sheet 2 except left and right margins where the base sheet 2 is a roll type. In a typical case, the plant pieces 4 are of one kind plant but plural kinds of plant pieces can be put on the base sheet 2 during the manufacturing process. The plant pieces 4 are sandwiched between the base sheet 2 and the top sheet 3, and are adequately supported by the base sheet 2 and the top sheet 3 because the top sheet 3 adheres to the base sheet 2 by the water-soluble resin material.

The plant sheet 1 does not include any soil with the plant pieces 4, so that the plant pieces 4 are required to have ability to grow from a dried surface where the plant sheet 1 is placed on a roof of a building. Many kinds of plants belonging to succulents and cactuses have good durability against dryness, and survive with a small amount of water absorbed in the base sheet 2 as well as the top sheet 3. Sedum is one of popular plants in Japan and other countries and is a genus of the natural order Crassulaceae, containing about 120 species, natives chiefly of the north temperate and frigid regions, and mostly perennial herbs with succulent leaves of varied form, but never compound. The white or yellow, rarely, pink or blue, flowers of Sedum are usually small and grouped in cymes. Sedums have a calyx of fine sepals, as many petals, usually ten stamens and five distinct carpels. Sedums can live as colonies on severe rock surfaces, e.g., sea shore and rock hill where no other plant can live and make growth with a very small amount of soil and natural rain water. Exemplified as one kind of Sedums are Sedum mexicanum Britt, Sedum orzifolium, Sedum sarmentosum, Sedum makinoi, Sedum arizoon var-floribundum, etc.

The plant pieces 4 in the plant sheet 1 can be chosen from many plants according to the regional climate at which the plant sheet 1 is placed. For example, in regions of a relatively cold weather, Sedum sarmentosum, Sedum makinoi, Sedum arizoon var-floribundum, and the like can be used because having strength against severe cold weather. In a region requiring strength against salt, Sedum mexicanum Britt, Sedum orzifolium, Sedum arizoon var-floribundum, etc. are suitable for such a region. The plant pieces 4 for Sedum kinds have a relatively light weight, e.g., of 400 g/m², and with one roll having width one meter and length ten meters, the weight of Sedum is very light weight around five kilograms.

With this plant sheet 1, because the plant sheet 1 does not contain any soil, and therefore, the plant sheet 1 is made with a very light weight and easily handled by construction workers. The plant pieces 4 are typically of 400 g/m² and about 5 kg/sheet, which makes the transportation and storage of plant sheet 1 easier. When the plant sheet 1 is set on a building roof, it is not required to reinforce the roof structure. The invented plant sheet 1 can be produced in a shape of a roll suitable for mass production and can be folded as to be easily carried by workers.

The plant sheet 1 is very thin, so that the plant sheet 1 is easily cut at the construction site and can be arranged for fit the site shape on which the plant sheet 1 is to be placed. The kinds of the plant pieces 4 can be selected according to region, climate, slope, surface condition, budget, etc., so that the plant sheet 1 can make growth of the plant pieces 4 in almost any area.

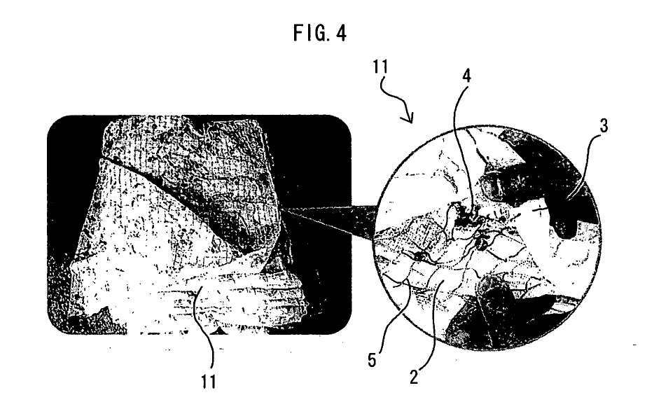

As a modified embodiment, a plant sheet 11 may contain a net 5 placed between the top sheet 3 and the base sheet 2 for supporting the plant pieces 4 as shown in FIG. 4. The net 5 has a function to support the plant pieces 4 in a case that the plant sheet 1 is set on a slope. Without such a net, the plant pieces 4 may be moved to a lower portion between the top sheet 3 and the base sheet 2 at a time of raining according to the force of gravity. Where the net 5 is placed between the top sheet 3 and the base sheet 2, the mesh of the net 5 is engaged with each plant pieces 4, so that each plant piece 4 can be immobilized between the top sheet 3 and the base sheet 2 and is prevented from positionally shifting due to the force of gravity. The net 5 has relatively large eyes so that the leaves and stems of the plant pieces 4 readily engage with the net 5. A preferred net 5 has a light weight and may be biodegradable but durable more than the top sheet 3 and the base sheet 2.

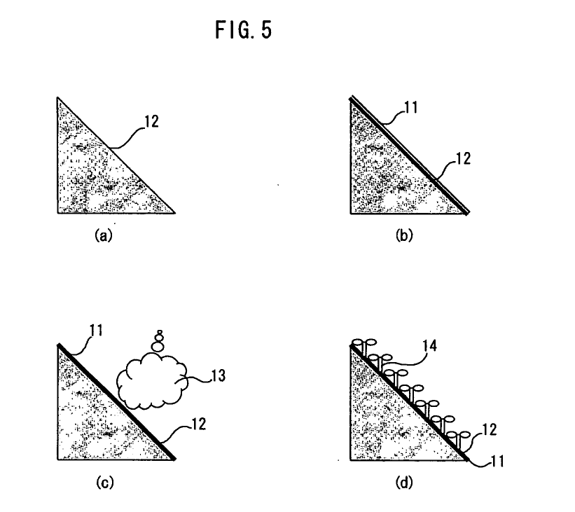

FIGS. 5(a) to 5(d) illustrate construction of the plant sheet 11 on a slope. FIG. 5(a) shows a slope 12. The slope 12 can be a concrete surface or rock wall extending along a road side. The plant sheet 11 is placed on the slope 12 as to spread on the surface of the slope as shown in FIG. 5(b). The base sheet 2 is placed to cover the slope surface, and the top sheet 3 appears as the top surface of the plant sheet 11. After the plant sheet 11 is spread on the slope 12, water 13 in a shape of, e.g., mists is supplied over the plant sheet 11. With such water, the water soluble resin material in the top sheet 3 is further solved to operate as a paste for the plant sheet 11 on the slope 12 to increase the adhering force between the slope surface and the plant sheet 11. Approximately a couple weeks later, the plant pieces 4 in the plant sheet 11 as shown in FIG. 5(d) make growth in absorbing a little amount of water and nutrients on the surface of the slope 12 and become plants 14.

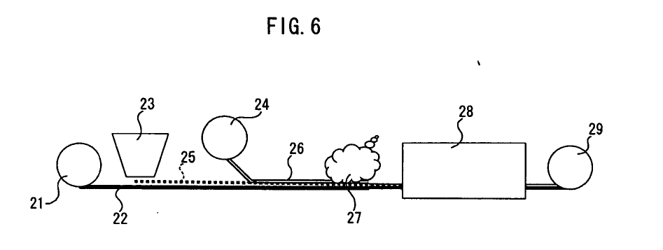

FIG. 6 illustrates a manufacturing method for the invented plant sheet. The base sheet 22 is provided in a shape of a roll 21 at a starting point of the manufacturing process. From the roll 21, the base sheet 22 is pulled horizontally on a table, not shown, and plant pieces 25 are scattered from a plant piece supplier 23 on the base sheet 22 in a uniformly dispersed manner. If the plant pieces 25 are concentrated in one area, the operator of this manufacturing process can easily move the concentrated pieces to scanty areas.

After the plant pieces 25 are scattered on the base sheet 22, a top sheet 26 is supplied from a top sheet roll 24 as to overlap the plant pieces 25 and the base sheet 22. Where the top sheet 26 is closely in contact with the base sheet 22, water 27 is supplied to render the top sheet 26 wet. The water 27 can be supplied in a form of mists or showers. Where the top sheet 26 receives the water, the paste in the top sheet 26 is solved and comes out of fibers, and the paste makes the top sheet 26 and the base sheet 22 adhering to each other, so that the plant pieces 25 located between the top sheet 26 and the base sheet 22 are firmly held by the top sheet 26 and the base sheet 22.

After the water 27 is supplied on the top sheet 26 to solve the water soluble resin material in the top sheet 26, the top sheet 26 and the base sheet 22 are sent to a dryer 28. In the dryer 28, relatively hot air is blown to the surface of the top sheet 26 to dry the plant sheet. The dryer 28 extends to cover each sheet size in this embodiment, but if the plant sheet is sent successively to a delivery roll 29, the dryer 28 can be made compact.

Because the plant sheet can be readily folded, the manufactured plant sheet can be in a folded sheet form. When the plant sheet is in a folded state, the folded sheets can be stored in a stacking manner and handled with ease.

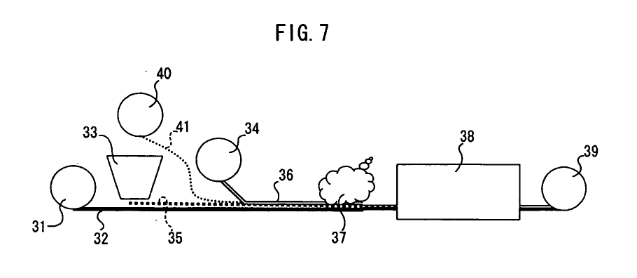

FIG. 7 illustrates another manufacturing method for the invented plant sheet. The base sheet 32 is provided in a shape of a roll 31 at a starting point of the manufacturing process. From the roll 31, the base sheet 32 is pulled horizontally on a table, not shown, and plant pieces 35 are scattered from a plant piece supplier 33 on the base sheet 32 in a uniformly dispersed manner.

Before a top sheet 36 supplied from a top sheet supplier 34 is attached onto the base sheet 32, a net 41 is supplied to the surface of the base sheet 32. The net 41 is utilized for preventing the plant pieces 35 positional shifting particularly on the slope by engaging with leaves and stems of the plant pieces 35.

After the net 41 is supplied on the base sheet 32, a top sheet 36 is supplied from a top sheet roll 34 as to overlap the plant pieces 35 and the base sheet 32. Where the top sheet 36 is closely in contact with the base sheet 32, water 37 is supplied to render the top sheet 36 wet. Where the top sheet 36 receives the water, the paste in the top sheet 36 is solved and comes out of fibers, and the paste makes the top sheet 36 and the base sheet 32 adhering to each other, so that the plant pieces 35 located between the top sheet 36 and the base sheet 32 are firmly held by the top sheet 36 and the base sheet 32.

The top sheet 36 and the base sheet 32 with the net 41 and the plant pieces 35 are then sent to a dryer 38. In the dryer 38, relatively hot air is blown to the surface of the top sheet 36 to dry the plant sheet, and the plant sheet is taken up at a delivery roller 39.

In the above manufacturing processes, the plant sheet is made in a form of a web or roll, but the plant sheet can be in a shape of a folded sheet or separated sheets, which are placed at the construction site in a tiling manner. Although in these embodiments, water is supplied after the top sheet is placed on the base sheet, water can be supplied to the top sheet before the top sheet is attached to the base sheet. In addition, to render the plant pieces are adequately attached to the top sheet and the base sheet, the plant pieces may be made wet before sandwiched between the top sheet and the base sheet.

The foregoing description of a preferred embodiment of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

1. A plant sheet for cultivating a plant, comprising:
a base sheet made of a naturally dissolvable fabric having a mesh structure;
a top sheet made of a tearable sheet having a mesh structure and placed on the base sheet, the top sheet being tom by growth of the plant; and
a plurality of plant pieces, from which the plant is able to make growth, arranged between the base sheet and the top sheet adhered in an area contact to the base sheet with a paste.

2. The plant sheet according to claim 1, wherein the top sheet is a fabric made of a water-soluble material and a biodegradable material.

3. The plant sheet according to claim 2, wherein the biodegradable material is a paper material.

4. The plant sheet according to claim 2, wherein the water-soluble material becomes the paste for making the top sheet and the base sheet adhere to each other.

5. The plant sheet according to claim 1, wherein the base sheet is made of a gauze material.

6. The plant sheet according to claim 1, wherein the plant pieces are made chiefly of leaves and stems of a plant capable of forming adventitious roots.

7. The plant sheet according to claim 1, wherein the plant pieces are of one or more succulent plants, one or more cacti, or a combination of succulent plants and cacti.

8. The plant sheet according to claim 1, wherein the plant pieces include one or more of sedums.

9. The plant sheet according to claim 1, wherein the plant sheet has a weight of 35 kg/m² or less.

10. A plant sheet for cultivating a plant, comprising:
a base sheet made of a naturally dissolvable fabric having a mesh structure;
a top sheet made of a tearable sheet having a mesh structure and placed on the base sheet, the top sheet being tom by growth of the plant;
a plurality of plant pieces, from which the plant is able to make growth, arranged between the base sheet and the top sheet adhered in an area contact to the base sheet with a paste; and
a net placed between the top sheet and the base sheet for supporting the plant pieces.

11. The plant sheet according to claim 10, wherein the top sheet is a fabric made of a water-soluble material and a biodegradable material.

12. The plant sheet according to claim 11, wherein the biodegradable material is a paper material.

13. The plant sheet according to claim 11, wherein the water-soluble material becomes the paste for making the top sheet and the base sheet adhere to each other.

14. The plant sheet according to claim 10, wherein the base sheet is made of a gauze material.

15. A manufacturing method for a plant sheet comprising the steps of:
preparing a base sheet as to spread on a work table;
scattering a plurality of plant pieces from which the plant is able to make growth;
overlaying a top sheet made of a water-soluble material, on the base sheet to sandwich the plant pieces between the top sheet and the base sheet;
spraying water on the top sheet to partly solve the top sheet and adhere the top sheet to the base sheet; and
drying the water contained at the top sheet and the base sheet.

16. The manufacturing method for the plant sheet according to claim 15, wherein the top sheet and the base sheet are provided in a form of rolls.

17. The manufacturing method for the plant sheet according to claim 15, further comprising the step of absorbing or blowing the air through the adhering sheets.

18. The manufacturing method for the plant sheet according to claim 15, further comprising the step of placing a net for supporting the plant pieces before overlaying the top sheet.

19. The manufacturing method for the plant sheet according to claim 15, wherein the top sheet is made of a tearable sheet having a mesh structure, and the base sheet is made of a naturally dissolvable fabric having a mesh structure.

20. The manufacturing method for the plant sheet according to claim 15, wherein the plant pieces are made chiefly of leaves and stems of a plant capable of forming adventitious roots.

21. The manufacturing method for the plant sheet according to claim 15, wherein the plant pieces are of one or more succulent plants, one or more cacti, or a combination of succulent plants and cacti.

22. The manufacturing method for the plant sheet according to claim 15, wherein the plant pieces include one or more of sedums.

23. A covering method for covering bare grounds and artificial surfaces, comprising the steps of:
placing the plant sheet according to claim 1 or claim 10 on a surface to which the plants are to be grown;
supplying water over the plant sheet to adhere the plant sheet to the surface.
